(19) United States
(12) Patent Application Publication
(10) Pub. No.: US 2025/0018632 A1
(43) Pub. Date: Jan. 16, 2025

(54) MOLDING EQUIPMENT FOR FUSION-REACTOR ARMORED CONDUCTOR

(71) Applicants: Hefei Institutes of Physical Science, CAS, Hefei City (CN); Yichun Longteng Mechanical and Electrical Co., Ltd, Yichun (CN)

(72) Inventors: Xuelong TAO, Hefei City (CN); Chao DAI, Hefei City (CN); Zuojiafeng WU, Hefei City (CN); Yu WU, Hefei City (CN); Feng LING, Hefei City (CN); Malin GONG, Hefei City (CN); Changneng ZHANG, Hefei City (CN)

(21) Appl. No.: 18/370,057

(22) Filed: Sep. 19, 2023

(30) Foreign Application Priority Data
Jul. 12, 2023 (CN) 2023108550047

(51) Int. Cl. B29C 48/35; B29C 48/03; B29C 48/25

(52) U.S. Cl. CPC B29C 48/35; B29C 48/03; B29C 48/2522; B29L 2031/34

(57) ABSTRACT

Molding equipment for a fusion-reactor armored conductor is provided, relating to the technical field of four-sided extrusion molding machines. The molding equipment includes a molding machine body, a pressing device and a shaping device are sequentially arranged inside the molding machine body. The pressing device includes four driving devices, each driving device includes a servo motor, a transmission device, a pressing roller, a power output shaft, and a pressing support. The servo motor drives the power output shaft to rotate through the transmission device, the pressing roller is arranged on the power output shaft, and the power output shaft is connected to the pressing support through a copper sleeve sliding bearing. The shaping device includes four shaping rollers. Each of the pressing device and the shaping device is internally provided with a roller adjusting device.

### CROSS-REFERENCE TO RELATED APPLICATION

This patent application claims the benefit and priority of Chinese Patent Application No. 2023108550047 filed with the China National Intellectual Property Administration on Jul. 12, 2023, the disclosure of which is incorporated by reference herein in its entirety as part of the present application.

### TECHNICAL FIELD

The present disclosure relates to the technical field of four-sided extrusion molding machines, in particular to molding equipment for a fusion-reactor armored conductor.

### BACKGROUND

The existing rectangular conductor armor has a cross-sectional shape of outer square and inner circle, which is generally made of high-strength stainless steel, and has a molding pressure of generally over 60 tons, so pressing rollers, shaping rollers and transmission devices have extremely important influence on the molding quality of rectangular conductor.

The existing extrusion molding machine for rectangular conductor generally employs the principle of four-roller single-pass flat extrusion compression necking molding. Under certain molding pressure conditions, the four rollers must rotate synchronously to ensure the same compression amount of the pressed conductor.

However, the existing molding machine usually has the following two shortcomings. First, in the existing molding machine, a frequency modulation motor is used for speed regulation, which cannot ensure the complete synchronization of the rotating speeds of multiple sets of rollers. Second, the existing pressing rollers are supported by rolling bearings, so the there is a risk that bearings are prone to internal crushing and deformation and the observation cannot be achieved.

Therefore, there is an urgent need for molding equipment for a fusion-reactor armored conductor to solve the problems above.

### SUMMARY

An objective of the present disclosure is to provide molding equipment for a fusion-reactor armored conductor for solving the technical problems in the prior art. A servo motor can be used to achieve synchronous movement of various pressing rollers. Moreover, a copper sleeve sliding bearing is connected to each pressing roller to increase a contact area, thereby eliminating the risk of damage during use.

In order to achieve the above objective, the present disclosure provides the following solutions.

Molding equipment for a fusion-reactor armored conductor is provided according to the present disclosure. The molding equipment includes a molding machine body. A feed port and a discharge port are respectively arranged on two sides of the molding machine body; a pressing device and a shaping device are sequentially arranged inside the molding machine body, and the pressing device is closer to the feed port than the shaping device.

The pressing device comprises four driving devices, each of the four driving devices comprises a servo motor, a transmission device, a pressing roller, a power output shaft, and a pressing support; the servo motor drives the power output shaft to rotate through the transmission device, the pressing roller is arranged on the power output shaft, the power output shaft is connected to the pressing support through a copper sleeve sliding bearing, and the four pressing rollers are capable of respectively contacting with four side faces of a rectangular conductor.

The shaping device comprises four shaping rollers, the four shaping rollers are capable of respectively contacting with the four side faces of the rectangular conductor.

Each of the pressing device and the shaping device is internally provided with a roller adjusting device, and the two roller adjusting devices are configured to adjust respective positions of the pressing roller and the shaping roller.

Preferably, the transmission device comprises a reducer, a driving wheel, a driven wheel, a power transmission shaft, and a power output shaft, an input end of the reducer is connected to an output end of the servo motor, an output end of the reducer is provided with the driving wheel. And the driving wheel is meshed with the driven wheel, the driven wheel is arranged at one end of the power transmission shaft, and an other end of the power transmission shaft is provided with a driving gear; a driven gear is arranged at one end, close to the power transmission shaft, of the power output shaft, the driving gear is meshed with the driven gear, and the pressing roller is arranged on the power output shaft.

Preferably, each of two ends of the power transmission shaft are provided with a bearing housing.

Preferably, the shaping device comprises a shaping bracket, the shaping bracket is provided with a cross-shaped through groove, the cross-shaped through groove comprises four sliding grooves, and the four shaping rollers are respectively arranged in the four sliding grooves.

Preferably, the shaping device further comprises four shaping supports, each of the four shaping supports is provided with a roller shaft, and the roller shaft is connected to a corresponding one of the shaping rollers through a rolling bearing.

Preferably, the roller adjusting device comprises a active wedge and a passive wedge, an inclined plane face of the active wedge is in contact with an inclined plane face of the passive wedge, the active wedge is provided with an adjusting threaded hole, and an adjusting screw is threaded into the adjusting threaded hole.

The active wedge is further provided with an elongated hole, the passive wedge is provided with a limit hole, and a limit lever penetrates through the elongated hole and the limit hole.

Preferably, a guide device is arranged at the feed port, a straightening device is arranged at the discharge port; the straightening device comprises a plurality of vertical straightening roller sets and a plurality of horizontal straightening rollers, the vertical straightening roller sets are staggered with the horizontal straightening rollers, and each of the vertical straightening roller sets comprises two vertical roller.

Preferably, the molding machine body comprises a front fixing plate, a rear fixing plate and a middle fixing plate, the feed port is provided on the front fixing plate, the discharge port is provided on the rear fixing plate, the middle fixing plate is arranged between the front fixing plate and the rear fixing plate, and the front fixing plate, the rear fixing plate and the middle fixing plate are all fixed on a support base.

Preferably, a water injection hole is formed in a side wall of the pressing support, a ring-shaped water injection tank is arranged on an inner wall of the pressing support, the water injection hole is connected to a water outlet of a reservoir through a water injection pipe, a water injection pump is arranged on the water injection pipe, a filtering device is arranged at the water outlet of the reservoir. A water inlet of the reservoir communicates with a collecting basin through a water return pipe, a water return pump is arranged on the water return pipe, and the collecting basin is located at a bottom of the molding machine body.

Compared with the prior art, the present disclosure has the following technical effects:

According to the present disclosure, a rectangular conductor is pressed by four pressing rollers in the pressing device, and the rectangular conductor is shaped by four shaping rollers in a shaping device. During this process, as the pressing roller is driven by the servo motor, the servo motor is controlled by a pulse signal, thus achieving the purpose of complete synchronization of the rotating speed of the pressing rollers. The pressing roller is provided with a copper sleeve sliding bearing to increase the contact area, thereby eliminating the risk of damage during use. The device has high reliability, and is stable in conductor pressing process.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of molding equipment for a fusion-reactor armored conductor in accordance with an embodiment of the present disclosure;

FIG. 2 is an exploded view of a molding machine body in molding equipment for a fusion-reactor armored conductor in accordance with an embodiment of the present disclosure;

FIG. 3 is a structural connection diagram of a driving device in molding equipment for a fusion-reactor armored conductor in accordance with an embodiment of the present disclosure;

FIG. 4 is a front sectional diagram of a shaping device in molding equipment for a fusion-reactor armored conductor in accordance with an embodiment of the present disclosure;

FIG. 5 is a structural schematic diagram of a roller adjusting device in molding equipment for a fusion-reactor armored conductor in accordance with an embodiment of the present disclosure;

FIG. 6 is a top view of a straightening device in molding equipment for a fusion-reactor armored conductor in accordance with an embodiment of the present disclosure;

FIG. 7 is a structural schematic diagram of a pressing support in molding equipment for a fusion-reactor armored conductor in accordance with an embodiment of the present disclosure.

In the drawings: 1 guide device; 2 pressing device; 201 servo motor; 202 reducer; 203 driving wheel; 204 driven wheel; 205 power transmission shaft; 206 bearing housing; 207 power output shaft; 208 pressing roller; 209 copper sleeve sliding bearing; 210 pressing support; 2101 water injection hole; 2102 water injection tank; 3 shaping device; 301 shaping bracket; 302 shaping support; 303 shaping roller; 304 roller shaft; 305 rolling bearing; 4 straightening device; 401 vertical straightening roller set; 402 horizontal straightening roller; 5 front fixing plate; 6 rear fixing plate; 7 middle fixing plate; 8 roller adjusting device; 801 adjusting screw; 802 active wedge; 803 passive wedge; 804 limit lever; 805 dial indicator.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide molding equipment for a fusion-reactor armored conductor for solving the technical problems in the prior art. A servo motor can be used to achieve synchronous movement of various pressing rollers. Moreover, a copper sleeve sliding bearing is connected to each pressing roller to increase a contact area, thus eliminating the risk of damage during use.

To make the above objectives, features and advantages of the present disclosure more apparently and understandably, the present disclosure is further described in detail below with reference to the accompanying drawings and specific embodiments.

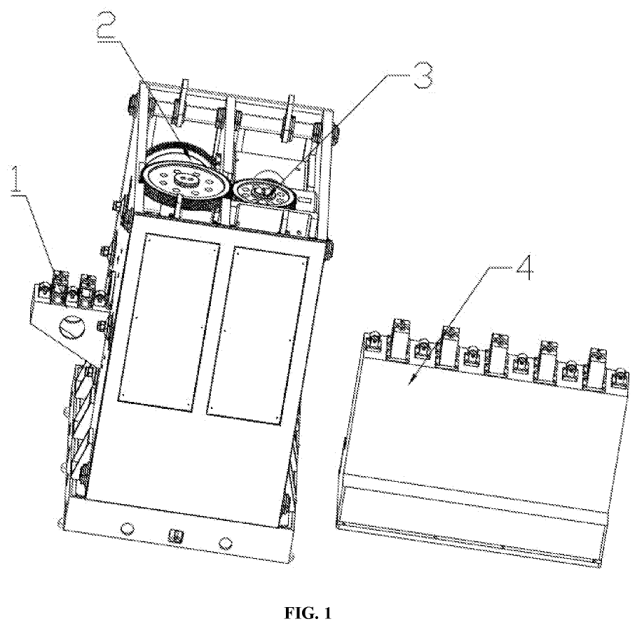

As shown in FIGS. 1 to. 4, it is provided molding equipment for a fusion-reactor armored conductor according to this embodiment. The equipment includes a molding machine body. A feed port and a discharge port are arranged on both sides of the molding machine body, respectively. A rectangular conductor can enter from the feed port and then is discharged from the discharge port. A pressing device 2 and a shaping device 3 are sequentially arranged inside the molding machine body, and the pressing device 2 is closer to the feed port than the shaping device 3.

The pressing device 2 includes four driving devices. Each driving device includes a servo motor 201, a transmission device, a pressing roller 208, a power output shaft 207, and a pressing support 210. The servo motor 201 drives the power output shaft 207 to rotate through the transmission device. As the servo motor 201 is controlled by a pulse signal, the four pressing rollers 208 can rotate synchronously. The pressing roller 208 is arranged on the power output shaft 207, and the power output shaft 207 is connected to the pressing support 210 through a copper sleeve sliding bearing 209, and the contact area with the pressing roller 208 can be effectively increased through the copper sleeve sliding bearing 209, thereby reducing the risk of damage. The four pressing rollers 208 can make contact with four sides of the rectangular conductor, respectively.

The shaping device 3 includes four shaping rollers 303, and the four shaping rollers 303 can make contact with four side faces of the rectangular conductor.

Each of the pressing device 2 and the shaping device 3 is internally provided with a roller adjusting device 8, and the two roller adjusting devices 8 can be used to adjust positions of the pressing roller 208 and the shaping roller 303, respectively, thus driving the shaping roller 303 and the pressing roller 20 to move close to, or far away from, the rectangular conductor.

In practical use, the rectangular conductor is fed from the feed port, and the servo motor 201 is started to drive the pressing roller 208 to rotate. The pressing roller 208 in rotation not only can drive the rectangular conductor to be conveyed towards a direction of the shaping device 3, but also can press the rectangular conductor to achieve the extrusion necking of the rectangular conductor. The rectangular conductor after passing through the pressing device 2 enters the shaping device 3, and then is shaped by the shaping roller 303, and finally the shaped rectangular conductor is conveyed out of the discharge port.

In addition, the pressing roller 208 is made of high-quality alloy tool steel. Through forging, carburizing forged, and the like, a crystalline phase structure inside the material is optimized, and the material hardness on the surface is strengthened, thereby improving the stiffness and fatigue resistance of the pressing roller 208.

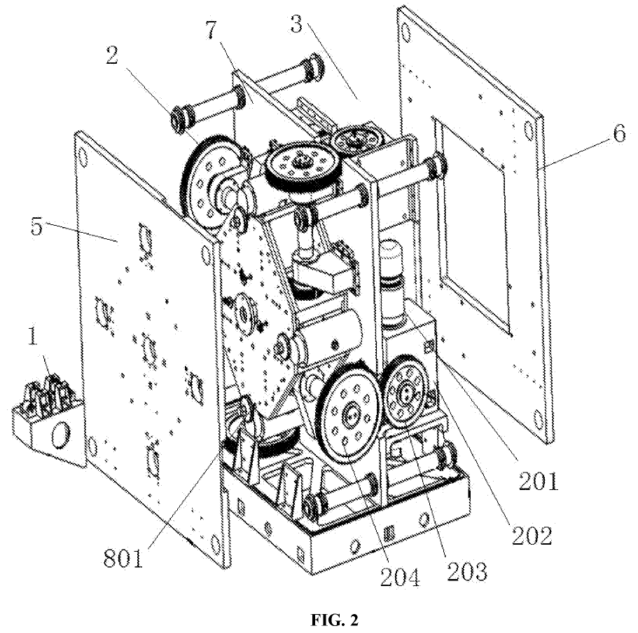

In this embodiment, as shown in FIG. 2, the transmission device includes a reducer 202, a driving wheel 203, a driven wheel 204, a power transmission shaft 205, and a power output shaft 207. An input end of the reducer 22 is connected to an output end of the servo motor 201, an output end of the reducer 202 is provided with the driving wheel 203, and the driving wheel 203 is meshed with the driven wheel 204. The driven wheel 204 is arranged at one end of the power transmission shaft 205, and the other end of the power transmission shaft 205 is provided with a driving gear. A driven gear is arranged at one end, close to the power transmission shaft 205, of the power output shaft 207, the driving gear is meshed with the driven gear, and the pressing roller 208 is arranged on the power output shaft 207.

In practical use, the servo motor 201 is started to drive the driving wheel 203 to rotate through the reducer 202. As the driving wheel 203 is meshed with the driven wheel 204, the driven wheel 204 can be driven to rotate. The driven wheel 204 drives the power transmission shaft 205 to rotate, and as the power transmission shaft 205 and the power output shaft 207 are in transmission connection through the driving gear and the driven gear, the power output shaft 207 and the pressing roller 208 are finally driven to rotate together.

In this embodiment, both ends of the power transmission shaft 205 are respectively provided with a bearing housing 206, and thus the rotary connection of the power transmission shaft 205 is achieved through the bearing housing 206.

In this embodiment, the shaping device 3 includes a shaping bracket 301. The shaping bracket 301 is provided with a cross-shaped through groove, and the center position of the cross-shaped through groove is the position of the rectangular conductor. The cross-shaped through groove includes four sliding grooves, and four shaping rollers 303 are respectively arranged in the four sliding grooves. The shaping rollers 303 are driven to move in the sliding grooves under the action of the roller adjusting device 8.

In this embodiment, the shaping device 3 further includes four shaping supports 302, each of which is provided with a roller shaft 304. Each roller shaft 304 is connected to one of the shaping rollers 303 through a rolling bearing 305. Specifically, an inner ring of the rolling bearing 305 is fixedly connected to a roller shaft 304, and an outer ring of the rolling bearing 305 is connected to the shaping roller 303.

The pressing roller 303, as a core part of the shaping conductor, is made of high-quality alloy tool steel. Through forging, carburizing forged, and the like, a crystalline phase structure inside the material is optimized, and the material hardness on the surface is strengthened. The size and surface roughness of the shaped rectangular conductor can meet the needs well.

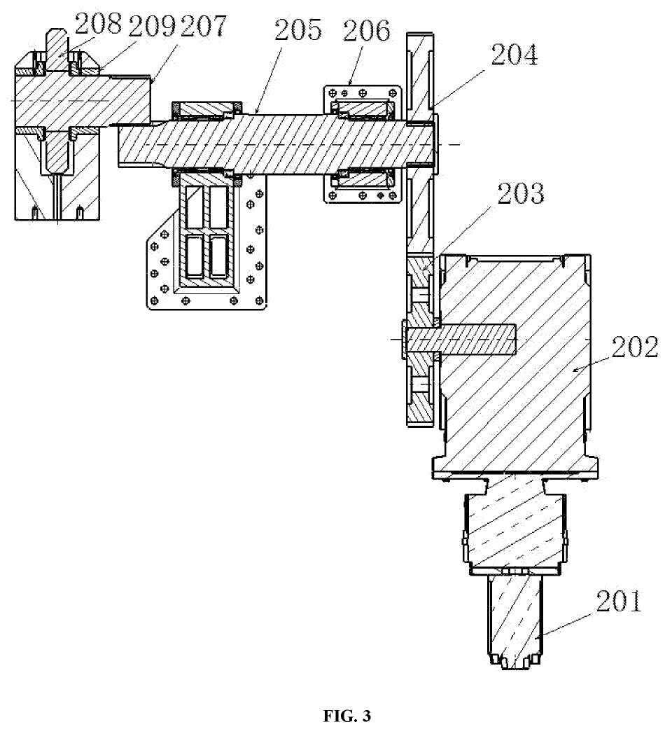

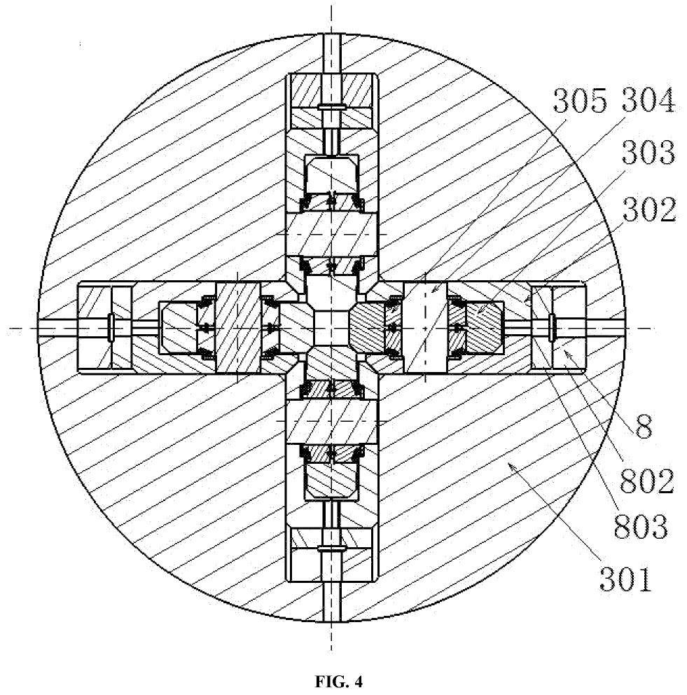

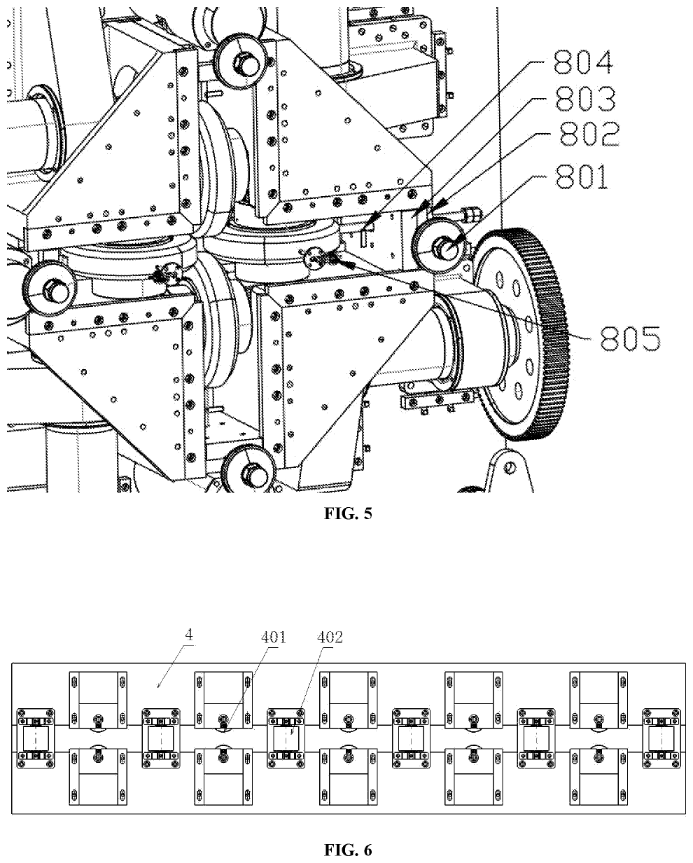

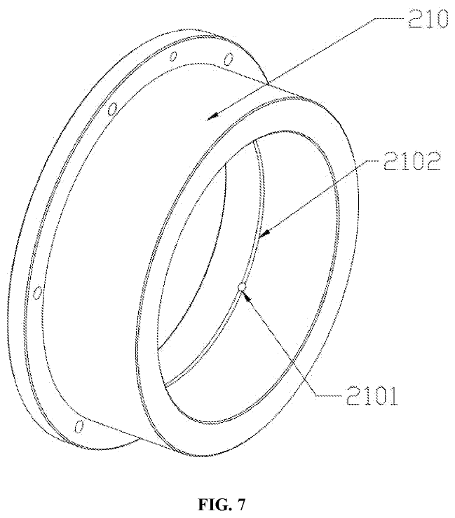

In this embodiment, as shown in FIG. 3, the roller adjusting device 8 includes a active wedge 802 and a passive wedge 803. An inclined plane face of the active wedge 802 is in contact with an inclined plane face of the passive wedge 803. The active wedge 802 is provided with an adjusting threaded hole, an adjusting screw 801 is threaded into the adjusting threaded hole. An axial direction of the adjusting screw 801 is parallel to a conveying direction of the rectangular conductor (that is, perpendicular to a surface direction in FIG. 3). One end, away from the active wedge 802, of the adjusting screw 801 is located outside the molding machine body and provided with a stop plate, thus preventing the adjusting screw 801 from axial movement.

The passive wedge 803 in the pressing device 2 is fixed to one face, away from the pressing roller 208, of the pressing support 210.

The passive wedge 803 in the shaping device 3 is fixed to one face, away from the shaping roller 303, of the shaping support 302.

When it is necessary to drive the pressing roller 208 or the shaping roller 303 to move towards the center position where the rectangular conductor is located, only the adjusting screw 801 needs to be rotated. Since the adjusting screw 801 cannot move axially, the active wedge 802 can be driven to move in an axial direction of the adjusting screw 801, so as to push the passive wedge 803 to move towards the center position where the rectangular conductor is located, thereby reducing a gap between the pressing rollers 208 or the shaping rollers 303. If the gap between the pressing rollers 208 or the shaping rollers 303 needs to be increased, it is only necessary to reversely rotate the adjusting screw 801. When the rectangular conductor passes through the pressing rollers 208 or the shaping rollers 3, the pressing rollers 208 or the shaping rollers 303 can be pushed to move outwards, thereby increasing the gap between the pressing rollers 208 or the shaping rollers 303.

In addition, the active wedge 802 is also provided with an elongated hole, and the passive wedge 803 is provided with a limit hole. An aperture of the elongated hole is larger than that of the limit hole, and axial directions of the elongated hole and the limit hole are both in a direction of the left and right horizontal lines in FIG. 3. In addition, a limit lever 804 is arranged in the elongated hole and the limit hole in a penetrating manner. The limit lever 804 plays a role of enabling the passive wedge 803 to move only in the axial direction of the limit lever 804.

It should be noted that, even when the position of the pressing roller 208 is adjusted, because of the small size of the adjustment required, the driving gear on the power transmission shaft 205 and the driven gear on the power output shaft 207 are free of relative disengaging, thereby achieving the normal power transmission between the power transmission shaft 205 and the power output shaft 207.

In addition, the pressing support 210 and the shaping support 302 are also provided with a measuring rod, and a dial indicator 805 is arranged outside of the molding machine body. A measuring end of the dial indicator 805 can abut against the measuring rod, thus monitoring specific positions of the pressing roller 208 and the shaping roller 303 in real time.

In this embodiment, a guide device 1 is arranged at the feed port, and a straightening device 4 is arranged at the discharge port. The straightening device 4 includes multiple vertical straightening roller sets 401 and multiple horizontal straightening rollers 402, the vertical straightening roller sets 401 are staggered with the horizontal straightening rollers 402, and each vertical straightening roller set 401 includes two vertical rollers. The horizontal straightening roller 402 is located below the vertical straightening roller set 401. Two vertical rollers in the vertical straightening roller set 401 respectively abut against two vertical side faces of the rectangular conductor, and the horizontal straightening roller 402 is used to abut against a lower surface of the rectangular conductor.

The guide device 1 and the straightening device 4 have the same structure except that the number of the horizontal straightening rollers 402 and vertical straightening roller sets 401 in the guide device 1 are different from the number of horizontal straightening rollers 402 and vertical straightening roller sets 401 in the straightening device 4. Three horizontal straightening rollers 402 and two groups of vertical straightening roller sets 401 are provided in the guide device 1 to ensure that the rectangular conductor can enter a correct position. The number of the horizontal straightening rollers 402 and vertical straightening sets 401 in the straightening device 4 is larger than the number of horizontal straightening rollers 402 and vertical straightening roller sets 401 in the guide device 1, and the specific number of the horizontal straightening rollers 402 and vertical straightening roller sets 401 can be adjusted according to actual needs.

In addition, the horizontal straightening rollers 402 and the vertical alignment roller set 401 are both fixed to a bottom plate by screws, and the positions of the horizontal alignment rollers 402 and the vertical alignment roller sets 401 are easily adjusted by screw connection. In addition, the roller parts of the horizontal straightening roller 402 and the vertical roller are hard plastic rollers with rolling bearings therein, which not only can straighten the conductor, but also can protect the surface of the rectangular conductor from damage.

In this embodiment, the molding machine body includes a front fixing plate 5, a rear fixing plate 6 and a middle fixing plate 7. The feed port is formed in the front fixing plate 5, the discharge port is formed in the rear fixing plate 6, and the middle fixing plate 7 is arranged between the front fixing plate 5 and the rear fixing plate 6. The middle fixing plate 7 is also provided with a through hole allowing the rectangular conductor to pass. The pressing device 2 is arranged between the front fixing plate 5 and the middle fixing plate 7, and the shaping device 3 is arranged between the rear fixing plate 6 and the middle fixing plate 7. The front fixing plate 5, the rear fixing plate 6 and the middle fixing plate 7 are all fixed to a support base. The support base may also be used for supporting the pressing device 2 and the shaping device 3.

In this embodiment, a water injection hole 2101 is formed in a side wall of the pressing support 210, and a ring-shaped water injection tank 2102 is provided on an inner wall of the pressing support 210, and the water injection hole 2101 can communicate with the water injection tank 2102. The water injection hole 2101 is connected to a water outlet of a reservoir through a water injection pipe, and a water injection pump is arranged on the water injection pipe. A filtering device is arranged at the water outlet of the reservoir. The filtering device is a filter with a pp cotton filter element, which is used for filtering the water flowing from the reservoir to the water injection hole 2101. A water inlet of the reservoir communicates with a collecting basin through a water return pipe, and a water return pump is arranged on the water return pipe. The water injection pump adopts a high-pressure water pump in the market, and the water return pump adopts a common water pump in the market, and the collecting basin is located in the support base at the bottom of the molding machine body.

In actual use, the water in the reservoir flows to the water injection hole 2101 through the water injection pump and the water injection pipe, and high-pressure water flows into the water injection tank 2102 through the water injection hole 2101. The water in the water injection hole 2101 and the water injection tank 2102 is used to wash the copper sleeve sliding bearing 209. The washed sewage falls down and into the collecting basin in the support base, and the water in the collecting basin flows into the reservoir through the water return pipe and the water return pump, thus forming a complete water circulation process.

Several examples are used for illustration of the principles and implementation methods of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. Molding equipment for a fusion-reactor armored conductor, comprising a molding machine body, wherein a feed port and a discharge port are respectively arranged on two sides of the molding machine body; a pressing device and a shaping device are sequentially arranged inside the molding machine body, and the pressing device is closer to the feed port than the shaping device;
the pressing device comprises four driving devices, each of the four driving devices comprises a servo motor, a transmission device, a pressing roller, a power output shaft, and a pressing support; the servo motor drives the power output shaft to rotate through the transmission device, the pressing roller is arranged on the power output shaft, the power output shaft is connected to the pressing support through a copper sleeve sliding bearing, and the four pressing rollers are capable of respectively contacting with four side faces of a rectangular conductor;
the shaping device comprises four shaping rollers, the four shaping rollers are capable of respectively contacting with the four side faces of the rectangular conductor; and
each of the pressing device and the shaping device is internally provided with a roller adjusting device, and the two roller adjusting devices are configured to adjust respective positions of the pressing roller and the shaping roller.

2. The molding equipment for the fusion-reactor armored conductor according to claim 1, wherein the transmission device comprises a reducer, a driving wheel, a driven wheel, a power transmission shaft, and a power output shaft, an input end of the reducer is connected to an output end of the servo motor, an output end of the reducer is provided with the driving wheel, and
the driving wheel is meshed with the driven wheel, the driven wheel is arranged at one end of the power transmission shaft, and an other end of the power transmission shaft is provided with a driving gear; a driven gear is arranged at one end, close to the power transmission shaft, of the power output shaft, the driving gear is meshed with the driven gear, and the pressing roller is arranged on the power output shaft.

3. The molding equipment for the fusion-reactor armored conductor according to claim 2, wherein each of two ends of the power transmission shaft are provided with a bearing housing.

4. The molding equipment for the fusion-reactor armored conductor according to claim 1, wherein the shaping device comprises a shaping bracket, the shaping bracket is provided with a cross-shaped through groove, the cross-shaped through groove comprises four sliding grooves, and the four shaping rollers are respectively arranged in the four sliding grooves.

5. The molding equipment for the fusion-reactor armored conductor according to claim 1, wherein the shaping device further comprises four shaping supports, each of the four shaping supports is provided with a roller shaft, and the roller shaft is connected to a corresponding one of the shaping rollers through a rolling bearing.

6. The molding equipment for the fusion-reactor armored conductor according to claim 1, wherein the roller adjusting device comprises a active wedge and a passive wedge, an inclined plane face of the active wedge is in contact with an inclined plane face of the passive wedge, the active wedge is provided with an adjusting threaded hole, and an adjusting screw is threaded into the adjusting threaded hole; and
the active wedge is further provided with an elongated hole, the passive wedge is provided with a limit hole, and a limit lever penetrates through the elongated hole and the limit hole.

7. The molding equipment for the fusion-reactor armored conductor according to claim 1, wherein a guide device is arranged at the feed port, a straightening device is arranged at the discharge port; the straightening device comprises a plurality of vertical straightening roller sets and a plurality of horizontal straightening rollers, the vertical straightening roller sets are staggered with the horizontal straightening rollers, and each of the vertical straightening roller sets comprises two vertical rollers.

8. The molding equipment for the fusion-reactor armored conductor according to claim 1, wherein the molding machine body comprises a front fixing plate, a rear fixing plate and a middle fixing plate, the feed port is provided on the front fixing plate, the discharge port is provided on the rear fixing plate, the middle fixing plate is arranged between the front fixing plate and the rear fixing plate, and the front fixing plate, the rear fixing plate and the middle fixing plate are all fixed on a support base.

9. The molding equipment for a fusion-reactor armored conductor according to claim 1, wherein a water injection hole is formed in a side wall of the pressing support, a ring-shaped water injection tank is arranged on an inner wall of the pressing support, the water injection hole is connected to a water outlet of a reservoir through a water injection pipe, a water injection pump is arranged on the water injection pipe, a filtering device is arranged at the water outlet of the reservoir; and
a water inlet of the reservoir communicates with a collecting basin through a water return pipe, a water return pump is arranged on the water return pipe, and the collecting basin is located at a bottom of the molding machine body.
